(19) United States
(12) Patent Application Publication
(10) Pub. No.: US 2018/0186023 A1
(43) Pub. Date: Jul. 5, 2018

(54) DEVICE FOR CUTTING PAPER AND OTHER GRAPHIC SUBSTRATES WOUND IN ROLLS

(71) Applicant: FOTOBA INTERNATIONAL S.R.L., Quaregna (BI) (IT)

(72) Inventor: Valter MADDALON, Pralungo (BI) (IT)

(21) Appl. No.: 15/738,289

(22) PCT Filed: Jul. 1, 2015
(86) PCT No.: PCT/IT2015/000172

§ 371 Date: Dec. 20, 2017

(51) Int. Cl. B26D 7/18; B26D 1/24; B26D 5/02; B26D 7/26

(52) U.S. Cl. CPC B26D 7/1854; B26D 1/245; B26D 5/04; B26D 7/2621; B26D 7/2635; B26D 5/02

(57) ABSTRACT

The invention relates to an automatic cutting device for printed graphic substrates. The device has a working plane configured to allow passage of a printed graphic substrate along a longitudinal direction (L) and a transverse cutting unit arranged at a slit of the working plane extending in a transverse direction (T) perpendicular to the longitudinal direction (L). The transverse cutting unit is movable along the slit in the transverse direction (T), and has a pair of uprights on which two pairs of counter-rotating blades are respectively mounted, the uprights being spaced apart in the longitudinal direction (L).

The present invention generally relates to the finishing of paper and other graphic substrates wound in rolls printed by way of digital restitution systems and in particular to an automatic cutting device.

It is known that graphic technique, including digital restitution, is more and more oriented towards printing by way of the ink-jet technology digital files on rolls of graphic substrates having the most varied characteristics and size.

There are known automatic cutting devices for the finishing and the cutting of printed substrates along a longitudinal direction corresponding to the feeding direction, as well as along a transverse direction perpendicular to the longitudinal direction. To this end, these cutting devices comprise a working plane configured to allow feeding of a printed substrate, at least one longitudinal cutting unit and at least one transverse cutting unit that are generally provided with pairs of counter-rotating blades. The counter-rotating blades of each pair are intended to contact opposite faces of the printed substrates and are arranged side by side so as to behave like scissors and allow to separate printed images from the respective longitudinal and transverse peripheral edges, which form processing scraps.

The longitudinal cutting units are oriented in the longitudinal direction of the printed substrates and are mounted on suitable cross-members which allow to position them at variable distances relative to each other in a transverse direction, perpendicular to the longitudinal direction, depending on the position of the longitudinal edges.

The transverse cutting units are movable along the transverse direction from one side to the opposite side of the working plane along a slit formed therein and generally comprise two pairs of blades that are spaced apart in the transverse direction.

The international publication WO 2006/126224 A1 in the applicant's name discloses an example of an automatic cutting device of the above-mentioned type.

It is known that in order to make a transverse cut on a printed substrate the latter is temporarily stopped and a transverse cutting unit is moved from one side to the opposite side of the working plane along the slit so as to make a first cut. The substrate is then made to advance in the longitudinal direction by a short predetermined distance and stopped again. The transverse cutting unit is operated a second time so as to make a second cut by running along the slit from one side to the opposite side of the working plane in the opposite direction with respect to the direction of the first cut. The scrap thus separated from printed substrate falls into the slit.

In order to cut scraps in the transverse direction it is therefore necessary to operate the transverse cutting unit twice, to stop the printed substrate two times and make it to advance in-between.

The digital printing industry is rapidly evolving and there is currently a strong need to reduce the time taken by cutting operations, in particular along the transverse direction. Therefore, cutting devices meeting this need are desirable, which is an object of the present invention.

Said object is achieved with a cutting device, whose main features are specified in the first claim, while other features are specified in the remaining claims.

An idea of solution underlying the invention is to provide a cutting device wherein the transverse cutting unit is provided with pairs of counter-rotating blades spaced apart in the longitudinal direction, which allows to carry out on a printed substrate two parallel cuts simultaneously in a single run of the cutting unit in the transverse direction. Thanks to this configuration it is possible to remarkably reduce the cutting time.

The supports of the counter-rotating blades of the transverse cutting unit arranged parallel to each other are movable relative to one another in the longitudinal direction, thus allowing to separate scraps having a different size in this direction.

Adjustment of the mutual distance of the supports, and therefore of the counter-rotating blades, may be done manually or automatically by means of linear actuators.

The transverse cutting unit may also advantageously comprise a supporting surface adapted to prevent scraps from falling on the shafts of the counter-rotating blades or, more generally, between their supports, thus affecting operation of the cutting unit.

The supporting surface may advantageously comprise a shaped portion configured so as to impart an arch shape to the scraps that facilitates its advancement and fall in the slit past the cutting unit. This feature of the invention is particularly effective in the case of printed substrates made of thin and light paper, that have a low rigidity and therefore tend to build up, thus making it difficult to discharge the scraps.

The transverse cutting unit may also comprise a pair of conveyor belts operatively connected to the pairs of counter-rotating blades mounted on any one of the supports. The conveyor belts have the function to contact and drag the scraps past the cutting unit, thus facilitating their discharge into the slit of the working plane. This feature of the invention is particularly effective in the case of printed substrates made of thin and light paper or paper made of materials that are prone to static electricity buildup, which tend to adhere to the rotating blades and make it very difficult and problematic to discharge scraps.

A printed substrate, generally coming from a roll, has a natural tendency to be rolled up again. There is therefore the risk that the leading edge of a printed substrate proceeding along the working plane is inserted in the slit for discharging the scraps. According to a further aspect of the invention, the cutting device advantageously comprises auxiliary supporting means configured to support a printed substrate when crossing the slit of the working plane in the longitudinal direction. The auxiliary supporting means may for example comprise a flap restrained along one of the edges of the portions of the working plane that face the slit along which the transverse cutting unit runs and the scraps are discharged. Alternatively, one or more blowers configured to dispense jets of air towards the slit may be employed, or a combination of both a flap and one or more blowers.

Further advantages and features of the cutting device according to the present invention will become clear to those skilled in the art from the following detailed and non-limiting description of embodiments thereof with reference to the accompanying drawings in which:

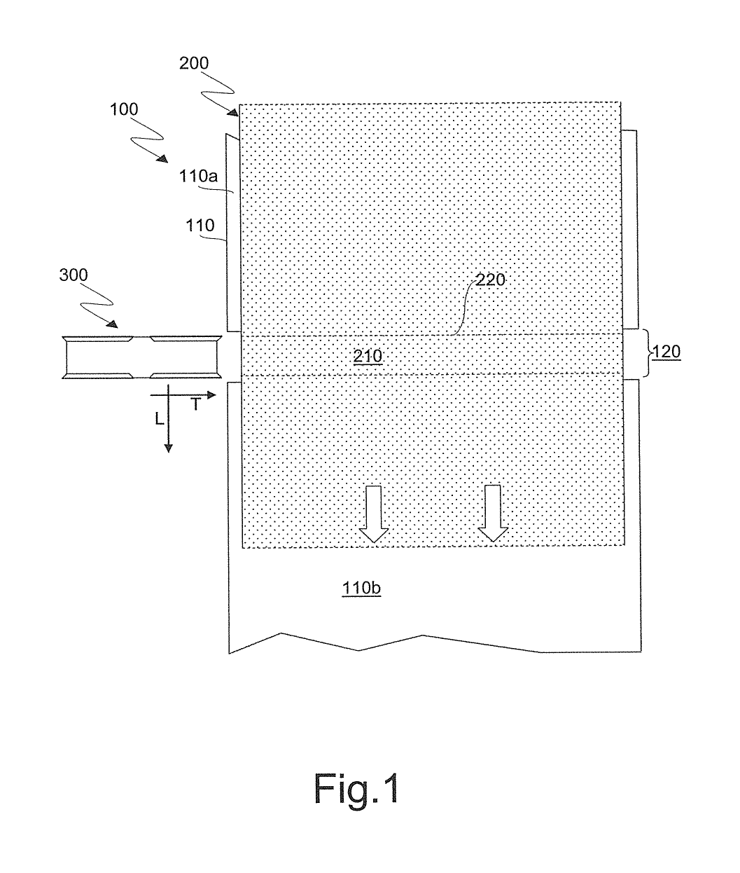

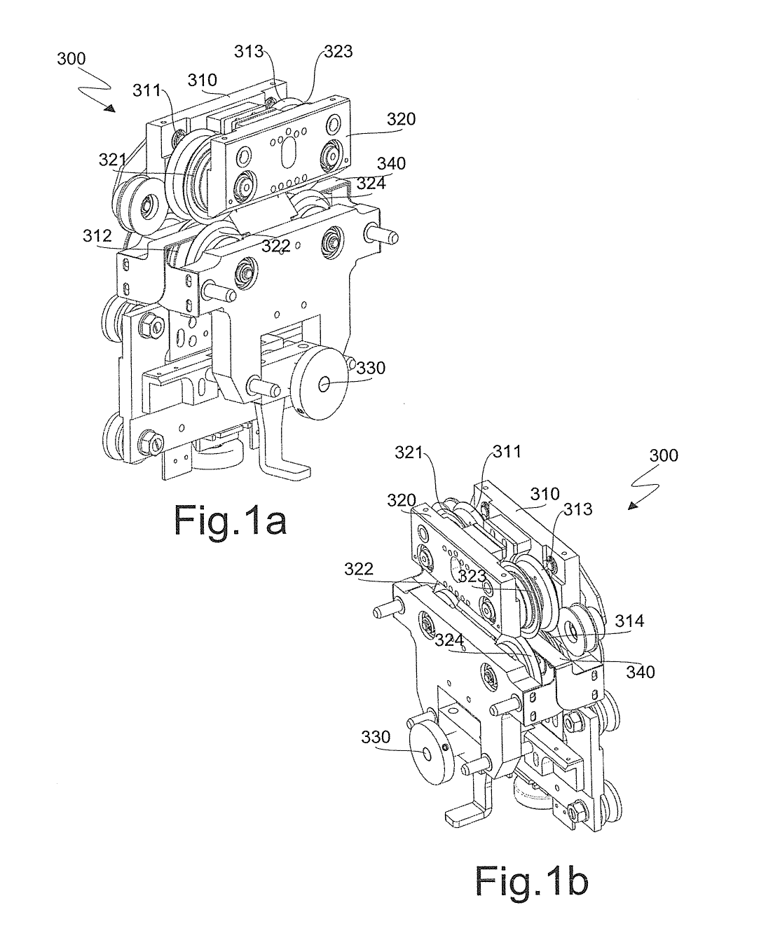

FIG. 1 is a top plan view schematically showing the working plane and the transverse cutting unit of a cutting device according to the invention;

FIGS. 1a and 1b are perspective views that show the transverse cutting unit of the cutting device of FIG. 1 from two different angles;

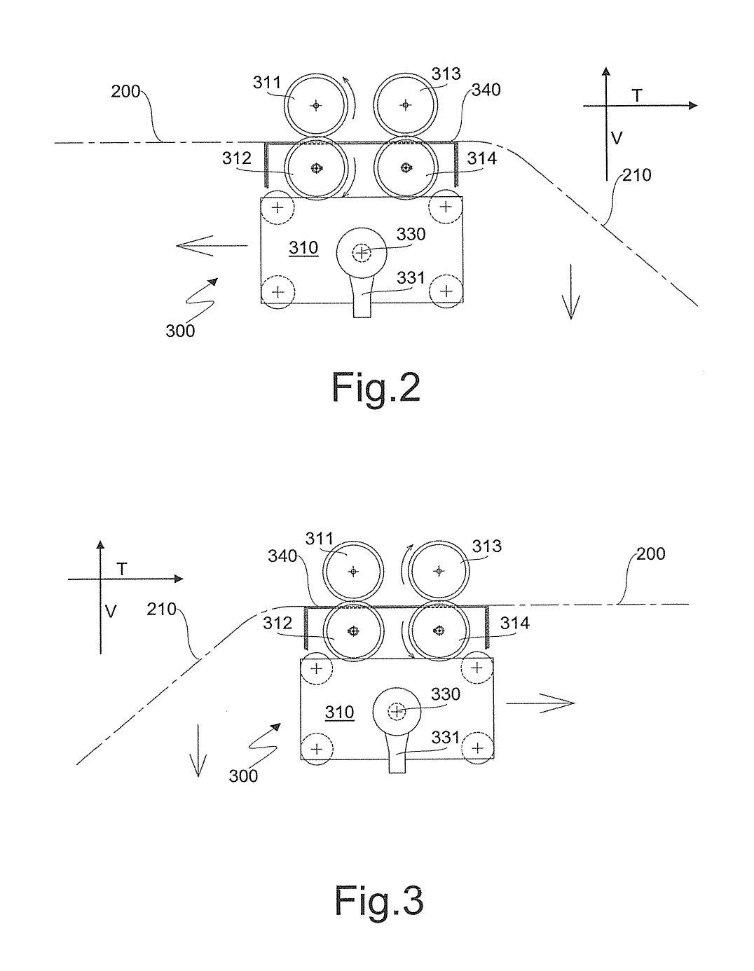

FIGS. 2 and 3 are front views that show the movements of the transverse cutting unit from one side to the opposite side of a working plane of the device of FIG. 1;

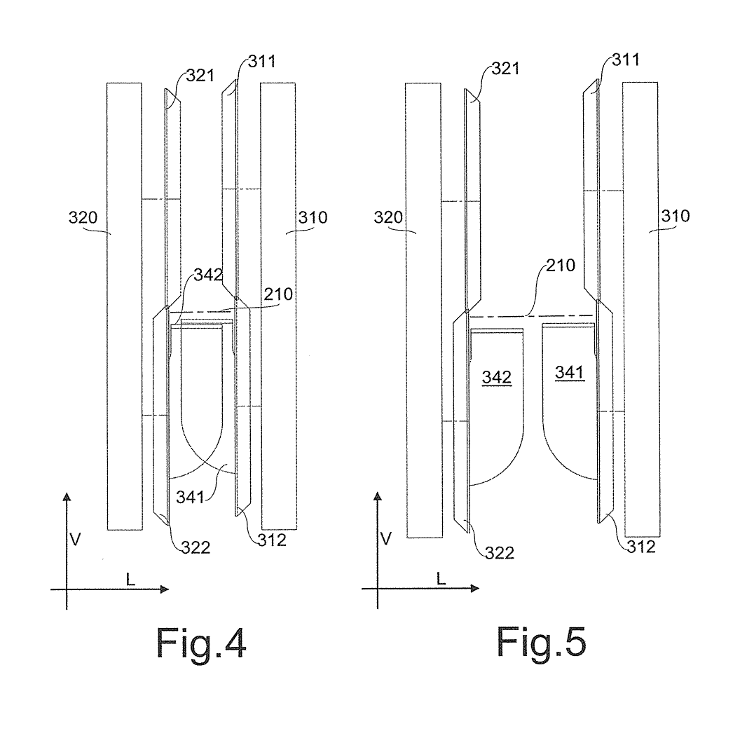

FIGS. 4 and 5 are side views of the transverse cutting unit showing a supporting surface for the scraps generated after cutting;

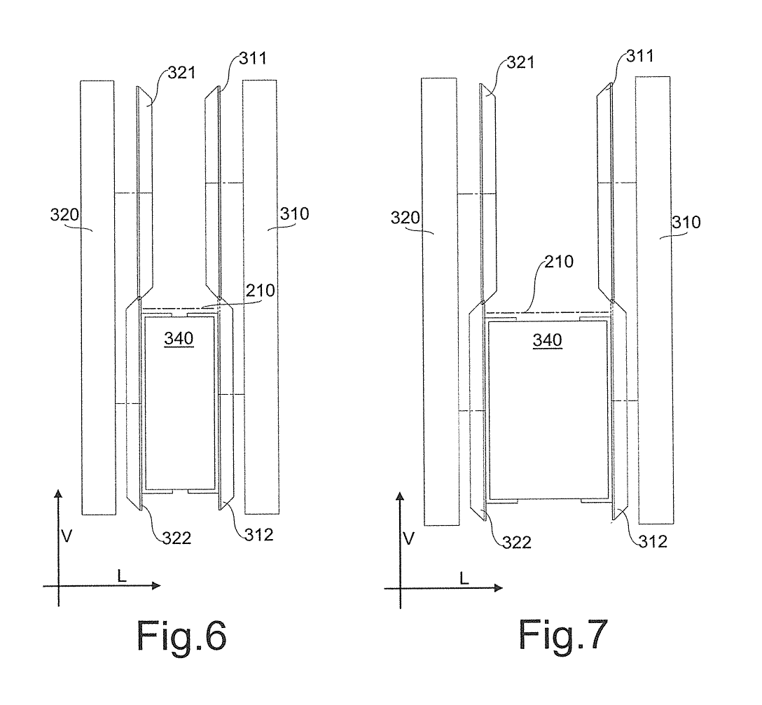

FIGS. 6, 7 and 8, 9 are side views of the transverse cutting unit showing supporting surfaces for the scraps according to alternative embodiments of the invention;

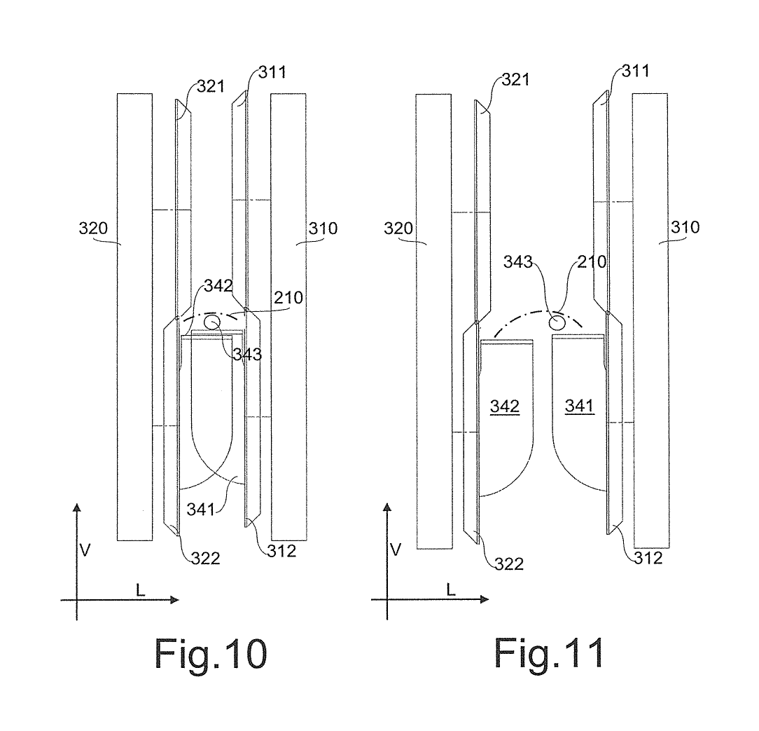

FIGS. 10 and 11 are side views of the transverse cutting unit showing a variant of the scrap supporting surface of FIGS. 4 and 5;

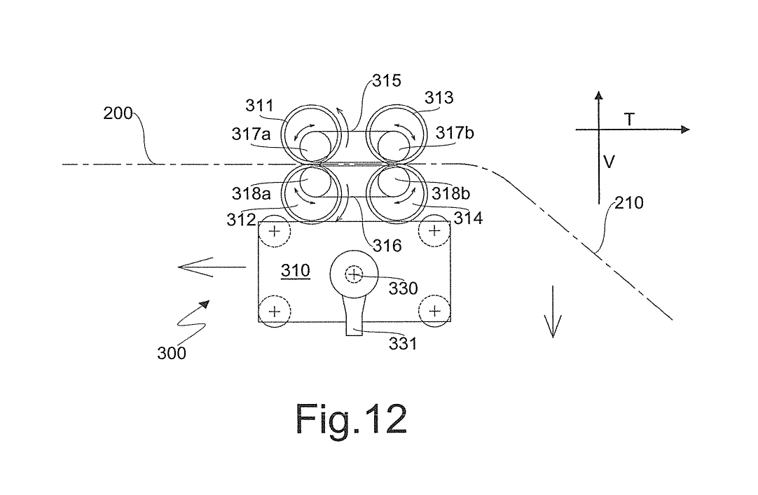

FIG. 12 is a front view schematically showing an embodiment of the cutting unit comprising auxiliary drag and discharging means of the scraps;

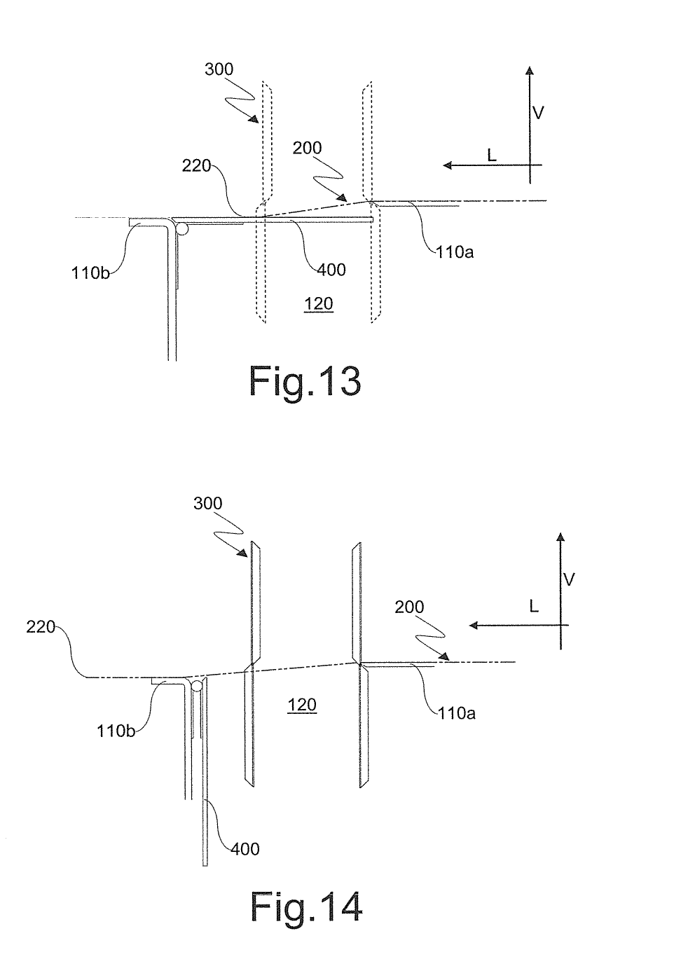

FIGS. 13 and 14 are side views of the device of FIG. 1 that schematically show auxiliary supporting means of the device according to the invention, configured to support a printed substrate in the passage between the first and the second portion of the working plane at the slit for transverse cuts;

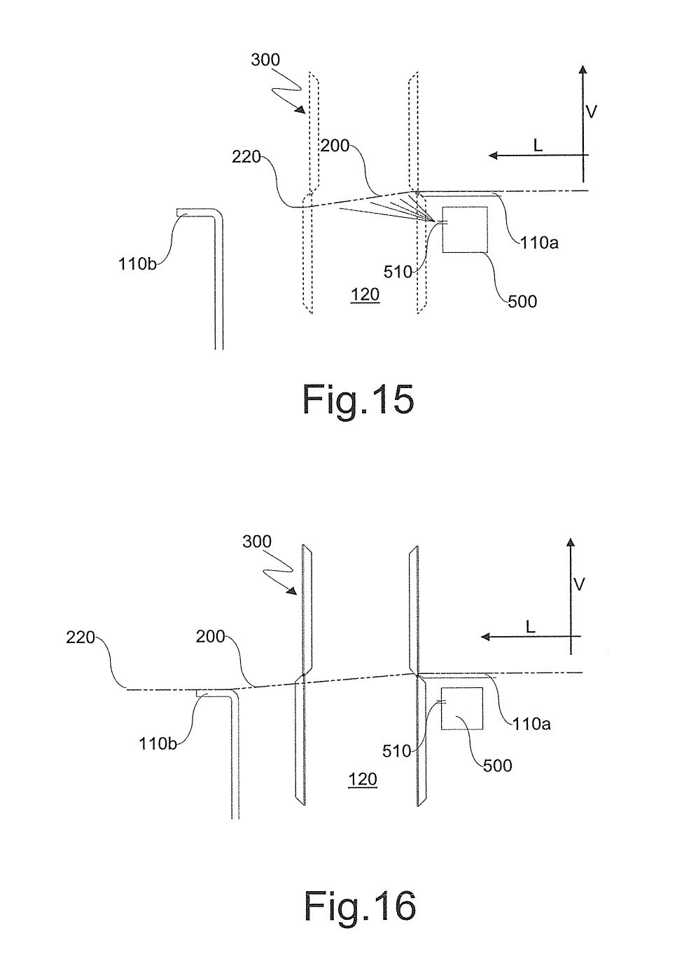

FIGS. 15 and 16 are side views similar to those of FIGS. 13 and 14 showing an alternative embodiment of the auxiliary supporting means of the device according to the invention;

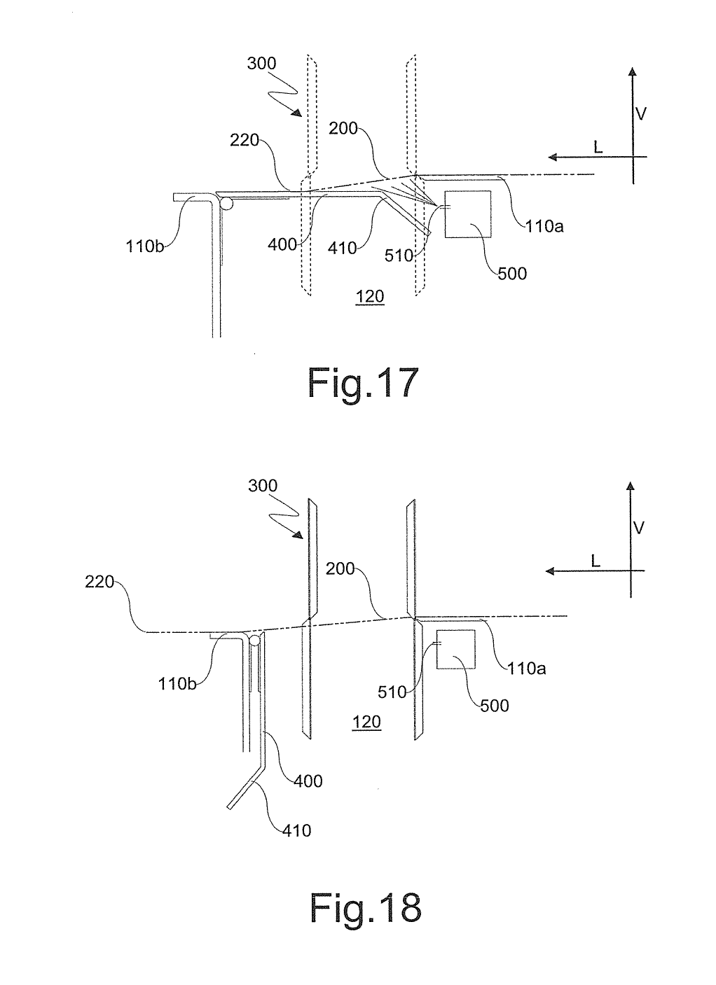

FIGS. 17 and 18 are side views similar to those of FIGS. 13, 14 and 15, 16 that show a further embodiment of the auxiliary supporting means of the device according to the invention.

FIG. 1 schematically shows an automatic cutting device 100 comprising in known manner a working plane 110 which is extended in a longitudinal direction L and is suitable to allow passage of a printed substrate 200 in a feeding direction parallel to the longitudinal direction L.

The cutting device 100 comprises a transverse cutting unit 300 arranged in correspondence with a slit 120 which stretches out in a transverse direction T, perpendicular to the longitudinal direction L.

The slit 120 divides the working plane 110 into two portions that are respectively indicated with reference numbers 110a and 110b, and allows movements of the transverse cutting unit 300 from side to side of the working plane and discharge of the scraps produced by the transverse cutting unit while cutting.

The transverse cutting unit 300, shown in FIGS. 1a and 1b from two different angles, is connected to the cutting device 100 in a movable manner in the transverse direction T, for example along a rail (not shown) fixed to a frame (not shown) of the cutting device 100.

FIGS. 2 and 3 are front views which schematically show the transverse cutting unit 300 of the cutting device 100 while operating on a printed substrate 200 such as a sheet of paper. In the figures, the printed substrate 200 is schematically shown by a dotted line, which shows a cross section thereof.

In FIG. 2, the cutting unit 300 is shown during a displacement in the transverse direction T from right to left, schematically indicated by an arrow, while in FIG. 3 the cutting unit 300 is shown during a displacement in the transverse direction T in the opposite direction, i.e. from left to right. The further arrows instead indicate a vertical direction V, perpendicular to the transverse direction T, along which scraps 210 progressively separated from the images printed on the substrate 200 by cutting fall down.

With reference to FIGS. 1a, 1b and 2 to 5, the cutting unit 300 comprises a pair of uprights 310, 320 on which pairs of counter-rotating blades are respectively mounted, in particular two pairs of blades on each support, which are respectively indicated with reference numbers 311, 312; 313, 314; 321, 322; 323, 324. The distance between the blades mounted on the uprights 310, 320 in the longitudinal direction L defines the size of the scrap 210 cut from the substrate 200 in the same direction.

FIGS. 2 and 3 only show the upright 310 of the cutting unit 300, on which pairs of blades 311, 312 and 313, 314 are mounted.

FIGS. 4 and 5 show that the uprights 310, 320 are movable relative to one another in the longitudinal direction L, so that the distance between the blades is variable, thus allowing not only to carry out a two cuts simultaneously, but also to adjust the cutting unit 300 to the size of the empty spaces present between the images printed on the substrate 200.

To this aim, the cutting unit 300 is provided with adjustment means e.g. comprising a worm screw 330 restrained to the two uprights 310, 320. The worm may e.g. be operatively connected to a crank 331 restrained thereto allowing to drive it manually, or to a motor (not shown) for automatic actuation.

Alternatively, the adjustment means may comprise one or more linear actuators of electrical, hydraulic or pneumatic type restrained to the uprights 310, 320 and operatively connected to a control system of the automatic cutting device 100.

By way of example, the distances between the blades of the cutting unit 300 may vary between 1 and 5 centimeters.

The cutting unit 300 further comprises at least one supporting surface 340 adapted to prevent the scrap 210 from falling on the shafts of the blades or, more generally, between the uprights 310, 320, thus affecting the operation of the cutting unit 300.

The supporting surface 340 stretches out between the uprights 310, 320 of the counter-rotating blades in the longitudinal L and transverse T directions and is arranged above the shafts of the counter-rotating blades with respect to the vertical direction V.

In the embodiment of the invention shown in FIGS. 4 and 5, the supporting surface 340 is e.g. formed by a pair of shaped plates one of which, indicated by reference number 341, is associated to the upright 310, while the other one, indicated by reference number 342, is associated to the upright 320. As shown in FIGS. 4 and 5, the plates 341, 342 are arranged at different heights in the vertical direction V. This allows to achieve a higher adjustment range of the distance between the blades. When the distance between the blades of the cutting unit 100 is at a minimum the shaped plates 341, 342, are above each other, whereas when the distance is at a maximum they are side by side or slightly spaced apart. The cutting unit 300 is configured so that the maximum distance between the plates 341, 342 is anyway lower than the foreseen width of the scrap 210, so that it cannot fall into the cutting unit 300.

In the illustrated embodiment, the plate 341 is e.g. arranged above the plate 342.

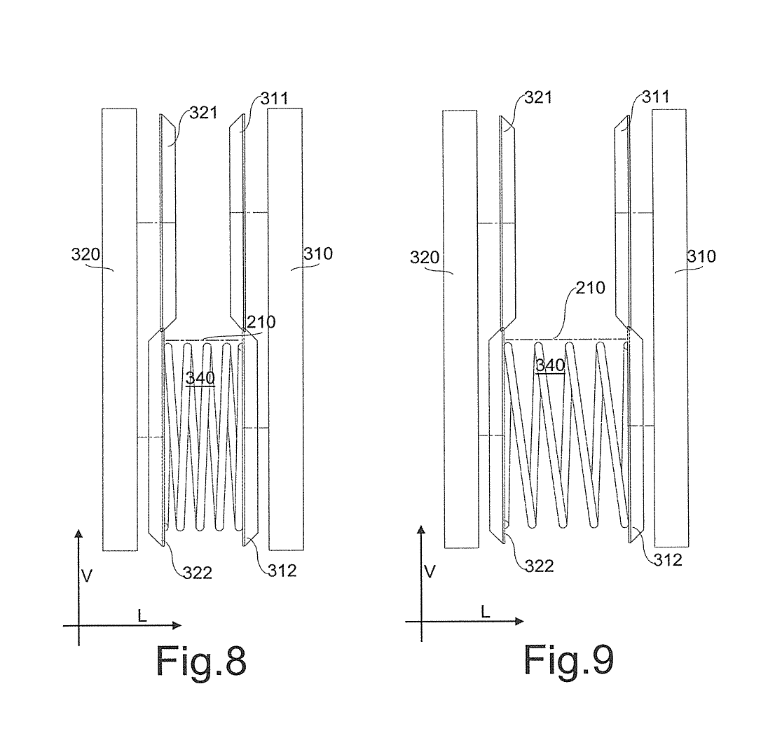

According to an alternative embodiment of the invention, the supporting surface 340 can be formed by inserting one or more resilient members coaxially to the shafts of the blades intended to contact the lower surface of the printed substrate 200. As shown in FIGS. 6 and 7 the resilient members could be made of an elastically deformable material such as rubber or foam rubber, or comprise helical springs, as shown in FIGS. 8 and 9.

The supporting surface 340 may advantageously comprise a shaped portion configured so as to impart an arch shape to the scraps, hence a greater flexural rigidity, so as to facilitate its movement past the cutting unit and fall into the slit. This feature of the invention is particularly effective in the case of printed substrates made of thin and light papers, that have a low flexural rigidity and tend to build up, thus making it more difficult to discharge the scraps.

As shown in FIGS. 10 and 11, similar to FIGS. 4 and 5, the shaped portion may e.g. be a rod 343 e.g. having a circular cross-section, the rod being fixed on one of the shaped plates 341, 342, in particular on the upper plate 341.

Now referring to FIG. 12, according to an embodiment of the invention the transverse cutting unit 300 may also comprise auxiliary dragging and discharging means configured to drag and discharge the scrap 210. The auxiliary dragging and discharging means are a pair of conveyor belts operatively connected to the pairs of counter-rotating blades mounted on one of the supports. Such conveyor belts, e.g. mounted on the upright 310, have the function to contact and drag the scrap 210 past the cutting unit 300, thus facilitating its discharge into the slit 120 of the working plane 110. This feature of the invention is particularly effective in the case of printed substrates made of thin and light papers or made of materials that are prone to static electricity build up, which tend to adhere to the rotating blades and make it very difficult and problematic to discharge the scraps.

In FIG. 12 the conveyor belts are schematically indicated by reference numbers 315, 316 and are mounted on respective pairs of pulleys 317a, 317b and 318a, 318b operatively connected for rotation to the blades 311, 312, 313, 314 through a suitable kinematic chain (not shown). In order to be able to operate in opposite rotation directions, as they result from the movements of the cutting unit 300 in both directions along the transverse direction T, the pulleys 317a, 317b and 318a, 318b are provided with freewheel mechanisms.

As schematically indicated in FIGS. 2 and 3, scraps 210 separated from the substrate 200 by the cutting unit 300 fall under the cutting device 100 through the transverse slit 120 of the working plane 110.

Once made a cut in the transverse direction T, the printed substrate 200 is made to advance in the longitudinal direction L until it reaches the next cutting position, in correspondence of which it is stopped so as to operate the cutting unit 300 again. A leading edge 220 of the support 200 resulting after each cut in the transverse direction T must cross the slit 120. Since the printed substrate 200 typically comes from a roll, it has a natural tendency to be rolled up again. There is therefore the risk that while proceeding in the longitudinal direction L the leading edge 220 of the printed substrate 200 enters the slit 120 rather than it proceeds on the second portion 110b of the working plane 110.

According to a further aspect of the invention, in order to solve this problem the cutting device 100 comprises auxiliary supporting means configured to support the printed substrate 200 in the passage between the first and second portions 110a, 110b of the working plane 110 at the slit 120.

Now referring to FIGS. 13 and 14, the auxiliary supporting means e.g. include a flap member 400 which is extended in the transverse direction T and is restrained along one of the edges of the portions 110a, 110b of the working plane 110 of the cutting device 100 that face the slit 120, for example the edge of the portion 110b.

The flap member 400 is movable between a first operating position, wherein it is substantially aligned with the working plane 110 and a second non-operating position, wherein it is arranged inside the slit 120 and does not interfere with the passage of the cutting unit 300. In the illustrated embodiment the flap member 400 is e.g. pivoted at the edge of the portion 110b of the working plane 110, but it will be understood that it could alternatively be pivoted in a completely equivalent way at the edge of the portion 110a of the working plane 110.

It will also be understood that the flap member 400 could also be slidably restrained to the portion 110a or the portion 110b of the working plane 110 and movable e.g. underneath it or retractable into a slit formed therein.

FIG. 13 shows the flap member 400 in the first operating position, wherein it allows the printed substrate 200 to cross the slit 120 of the working surface 110. In this condition, the cutting unit 300, schematically shown by way of dotted lines, is not operating, it is located at one end of the working plane 110 and does not interfere with the passage of the printed substrate. FIG. 14 shows instead the flap member 400 rotated inside the slit 120 of the working plane 110. In this position the flap member does not interfere with the movement of the cutting unit 300 along the slit 120, thus allowing to carry out cuts along the transverse direction T.

According to an alternative embodiment of the invention, the supporting means may comprise a blowing member 500 arranged below the working plane 110 in the vertical direction V and configured to deliver a jet of air at the slit 120 during the passage of the printed substrate 200 after each transverse cut. The blowing member 500 may e.g. be in the form of a single duct stretching out in the transverse direction T, provided with a dispensing slit 510 stretching out in the same direction through which air jets may be blown. There may be alternatively used a number of blowing members arranged in parallel.

FIGS. 15 and 16 respectively show the blowing member in an operating condition, wherein it delivers a jet of air towards the printed substrate 200 crossing the slit 120 and in a non-operating condition, wherein it does not blow any jet of air.

According to a further variant of the invention it is possible to combine the flap member 400 and the blowing member 500. As shown in FIGS. 17 and 18 the flap member 400 includes a bent portion 410 directed downwards with respect to the vertical direction V and towards the dispensing slit 510 of the blowing member 500 in the first operating position, wherein the flap member 400 is substantially aligned with the working plane 110. As in the embodiment described above, the blowing member 500 is arranged underneath the working plane 110 in the vertical direction V close to the slit 120. In the first operating position the bent portion 410 of the flap member 400 serves as a guide to drive air jets dispensed by the blowing member 500 towards the printed substrate 200.

The invention has herein been described with reference to preferred embodiments thereof. It is to be understood that there may be further embodiments relating to the same inventive idea, as defined by the scope of protection of the claims set forth below.

1. An automatic cutting device for printed graphic substrates, said device comprising a working plane configured to allow passage of a printed graphic substrate along a longitudinal direction (L) and a transverse cutting unit arranged at a slit of said working plane extending in a transverse direction (T) perpendicular to said longitudinal direction (L), said transverse cutting unit being movable along said slit in said transverse direction (T), wherein the transverse cutting unit comprises a pair of uprights on which two pairs of counter-rotating blades are respectively mounted, said uprights being spaced apart in the longitudinal direction (L).

2. The automatic cutting device according to claim 1, wherein said uprights are movable relative to one another in the longitudinal direction (L).

3. The automatic cutting device according to claim 2, wherein the transverse cutting unit is provided with adjustment means for adjusting the position of the uprights, said adjustment means comprising a worm gear restrained to each of the uprights, said worm gear being operatively connected to a crank or to a motor.

4. The automatic cutting device according to claim 2, wherein the transverse cutting unit is provided with means for adjusting the position of the uprights, said adjusting means comprising a linear actuators of an electric, hydraulic or pneumatic type restrained to the uprights and operatively connected to a control system of the automatic cutting device.

5. The automatic cutting device according to claim 1, wherein the transverse cutting unit further comprises a supporting surface adapted to support scraps separated from a printed graphic substrate, said supporting surface extending between the uprights of the counter-rotating blades in the longitudinal (L) and transverse (T) directions and being arranged above the shafts of the counter-rotating blades with respect to a vertical direction (V) perpendicular to the longitudinal (L) and transverse (T) directions.

6. The automatic cutting device according to claim 5, wherein the supporting surface is made up of a pair of shaped plates respectively associated with the uprights.

7. The automatic cutting device according to claim 6, wherein said shaped plates are arranged at different heights in the vertical direction (V) so that they may be superimposed.

8. The automatic cutting device according to claim 5, wherein the supporting surface comprises a shaped portion configured so as to allow a scrap to take an arch shape.

9. The automatic cutting device according to claim 7, wherein said shaped portion is a rod with a circular cross-section fixed on an upper shaped plate of the pair of shaped plates.

10. The automatic cutting device according to claim 5, wherein the supporting surface is made up of a resilient members coaxially fitted on the shafts of the blades intended to contact a lower surface of the printed graphic support.

11. The automatic cutting device according to claim 10, wherein said resilient members comprise members made of an elastically deformable material or helical spring members.

12. The automatic cutting device according to claim 1, further comprising auxiliary supporting means configured to support a graphic printed substrate in correspondence of the slit of the working plane.

13. The automatic cutting device according to claim 12, wherein said auxiliary supporting means comprise a flap member extending in the transverse direction (T) and restrained along one of the edges of the portions of the working plane facing the slit.

14. The automatic cutting device according to claim 12, wherein said auxiliary supporting means comprise a blowing member arranged underneath the working plane in the vertical direction (V) and configured to blow a jet of air at the slit.

15. The automatic cutting device according to claim 12, wherein said auxiliary supporting means comprise a flap member extending in the transverse direction (T) and restrained along one of the edges of the portions of the working plane facing the slit, as well as a blowing member arranged underneath the working plane in the vertical direction (V) and configured to blow a jet of air at the slit, said flap member comprising a portion bent downwards relative to the vertical direction (V) and facing a dispensing slit of the blower.
